(19) United States
(12) Patent Application Publication
(10) Pub. No.: US 2014/0098819 A1
(43) Pub. Date: Apr. 10, 2014

(54) CONVERGENCE NETWORK BASED ON IDENTIFIER AND COMMUNICATION METHOD USING THE SAME

(71) Applicant: Electronics and Telecommunications Research Institute, Daejeon (KR)

(72) Inventors: Tae Wan YOU, Daejeon (KR); Jung Im KIM, Daejeon (KR); Hee Young JUNG, Daejeon (KR)

(21) Appl. No.: 13/943,546

(22) Filed: Jul. 16, 2013

(30) Foreign Application Priority Data
Oct. 8, 2012 (KR) 10-2012-0111401

(51) Int. Cl. H04L 12/715

(52) U.S. Cl. CPC H04L 45/04
USPC 370/392

(57) ABSTRACT

A convergence network based on an identifier and a communication method using the same are provided. The convergence network based on the identifier includes an underlying network including a plurality of communication entities and an access router configured to separate IDs and locators of the communication entities; at least one domain network configured in an overlay form using the access router, and configured to have a different identifier based on a communication type or a service type; and a global name server GNS configured to register an identifier for identifying each of a communication entities and a domain network. The communication entities communicate over the at least one domain network using the identifier.

### CROSS-REFERENCE TO RELATED APPLICATIONS

This application claims priority to and the benefit of Korean Patent Application No 10-2012-0111401 filed in the Korean Intellectual Property Office on Oct. 8, 2012, the entire contents of which are incorporated herein by reference.

### TECHNICAL FIELD

The present invention relates to a convergence network based on an identifier, and more particularly, to a convergence network based on an identifier that differently configures a domain network using a programmable overlay scheme in an underlying network, based on a communication type a service type, defines a new identifier for the configured domain network, and enables communication between different domain networks based on the defined identifier, and a communication method using the same.

### BACKGROUND ART

1) Internet Protocol (IP) Based Internetworking Architecture

Currently, the IP based Internet has been increasing its role as a social infrastructure as well as a current communication infrastructure since 1960. Accordingly, in the Internet that simply supports only connectivity between computers, the number of terminals, such as mobile phones, small sensors, and the like, which access the Internet is gradually increasing.

Conducted researches show that the Internet designed 40 year ago cannot be maintained any more due to an increase in the number of terminals and the appearance of various services. Representatively, a lack of scalability and security is one of the well-known reasons.

In order to newly design the Internet having constraints in that the Internet is incapable of flexibly coping with sudden circumstances such as various user requirements, the increase in the number of terminals, threats to security, and the like, researches on clean-slate based future Internet architecture are conducted. This architecture has requirements that the architecture needs to be designed to be capable of supporting a new communication paradigm as well as existing problems such as mobility, security, scalability, and the like.

In particular, a communication paradigm to be newly supported may be mobility support (intrinsic mobility support architecture) and content based communication support

2) Intrinsic Mobility Support And Internet ID/LOC Separation Architecture

In an initial design, the Internet has considered only communication between a small number of fixed computers and a small number of applications. Consequently, the Internet has many problems in supporting a variety of services together with a large number of mobile terminals.

One of the most intrinsic problems is duplicate use of an identifier (ID) and a locator (LOC) of an IP address. Accordingly, the Internet is designed to be incapable of supporting mobility and the like. The IP address is allocated to an interface of a terminal and is changed when a connection point of the terminal varies. This is because changing the IP address disconnects all, of the communication sessions currently in connection, Under such a duplicate structure of the IP address, mobility has been supported using a patch solution as a mobile IP. However, due to complexity of control, additional equipment, operation overhead, and the like, actual adaptation becomes an issue.

IP duplicability is known as an intrinsic reason that causes routing scalability. To solve the above problem, ID/LOC separation needs to be designed to separate duplication of the ID and the LOC of the existing IP address, This requirement is known as a basic requirement of the future Internet architecture. 3) Content Based Networking Service

Currently, most of the traffic on the Internet traffic is caused by multimedia and a large capacity of multimedia service is generally predicted to gradually increase. Accordingly, the number of content delivery network (CDN) providers such as Akami capable of recognizing a network circumstance and servicing more effective contents are increasing. It is different from a third service such as peer to peer (P2P), which is a typical multimedia sharing service, and Bittorent,

In particular, in the future Internet architecture, research on a named data network (NDN) and an information centric network (ICN) that considers not a current client-server form but content itself as a service and thereby designs a network for supporting the content is actively conducted.

Such research aims to configure a network capable of effectively transmitting and using contents through an in-network cache scheme together with a method of retrieving, using, and even authenticating content using a name of the content itself.

4) Software Based Networking Technology

In the current Internet, protocols for control barely exist, which is different from other networking technologies. Accordingly, it is not easy to measure information associated with data transmission and perform traffic engineering. Setting and a dynamic change of a router, a switch device, and the like for data transmission can be handled only by a skilled operator. In particular, for a variety of services operating on a network, it is not easy to change networking resources.

In addition to lack of such a control plane, a software defined network (SDN) for flexibly reflecting appearance of various services, and new requirements in a network infrastructure has started to become magnified. In particular, necessity of the SDN has been raised together with a network virtualization technology capable of configuring new protocols and network in networking equipment already installed. Through this, a method capable of configuring a flexible network independent from predetermined networking hardware is proposed.

Currently, the SDN has been embodied in equipment capable of supporting network virtualization of an IP layer such as openflow and has been discussed. As an important factor of the future Internet, a wide meaning of SDN such as designing a networking operating system for a network itself is also under discussion.

Consequently, in the future Internet, all of the terminals will be mobile terminals and communication architecture based on large data such as multimedia needs to be supported. To this end, a network also needs to recognize the above communication and service type.

A technology that may configure a flexible network capable of supporting a new service and the like under currently configured network architecture is required.

In particular, for interworking between independent and autonomous networks or domains that are configured based on each necessity, inter-networking architecture is necessarily required and needs to be configured based on an identifier of a communication entity. The inter network architecture based on an identifier needs to be configured to be flexible.

### SUMMARY OF THE INVENTION

The present invention has been made in an effort to provide a convergence network based on an identifier that differently configures a domain network using an overlay scheme on an underlying network based on a communication type or a service type, defines a new identifier for the configured domain network, and enables communication between different domain networks based on the defined identifier, and a communication method using the same.

However, the object of the present invention is not limited to the aforementioned description and other objects not described above may be clearly understood to those skilled in the art from the following description.

An exemplary embodiment of the present invention provides a convergence network based on an identifier, the convergence network including: an underlying network including a plurality of communication entities and an access router configured to separate IDs and locators of the communication entities; at least one domain network configured in an overlay form using the access router, and configured to have a different identifier based on a communication type or a service type; and a global name server (GNS) configured to register an identifier for identifying each of a communication entities and a domain network. The communication entities communicate over the at least one domain network using the identifier.

The identifier may include an end point ID (EID) for identifying the communication entity and a domain ID (DID) for identifying the domain network.

The communication entity may obtain the locator and the DID from the access router at the underlying network of the communication entity in the case of being connected to any one domain network, and thereby determine whether the communication entity is connected to a new domain network using the obtained locator and DID, and may request the GNS to register the EID and the DID of the communication entity when the communication entity is connected to the new domain network as a result of determining.

The communication entity may provide the EID and the locator of the communication entity to the access router and thereby request the access router to register the provided EID and locator to a domain registry.

The communication entity may provide a name of a destination to the GNS, and may receive an EID and a DID corresponding to the name of the destination from the GNS.

The domain network may include: a plurality of domain routers (DRs) configured in the overlay form using the access router; and a domain designate router (DDR) selected from among the plurality of DRs as a DR to observe a corresponding domain network.

When receiving a data message from a communication entity of a source, the DR may obtain a locator with respect to an EID of a destination included in the received data message, and may transmit the data message to a communication entity of the destination via an access router of the destination based on the obtained locator.

When receiving a data message from a communication entity of a source, the DR may forward the received data message to a DDR of the source, the DDR of the source may perform a hash operation using a DID of a destination included in the forwarded data message, and may transmit the data message to a DDR of the destination based on a result of performing, and the DDR of the destination may transmit the data message to a communication entity of the destination via an access router of the destination based on a locator with respect to an EID of the destination included in the transmitted data message.

The domain network may be configured in a distributed hash table (DHT) based ring form.

The convergence network may use a protocol stack including a physical layer, an underlying network layer based on an Internet protocol (IP) address, a domain layer based on a DID for identifying a domain network, a transport layer based on an EID, and an application layer.

Another exemplary embodiment of the present invention provides a communication method using a convergence network including an underlying network, at least one domain network configured in an overlay form using an access router of the underlying network and configured to have a different identifier based on a communication type or a service type, and a GNS, the method including: receiving, by an access router or a DR of a source, a data message of a communication entity of the source; transmitting, by the access router or the DR of the source, the data message to an access router of a destination based on as locator with respect to an identifier of the destination included in the received data message; and transmitting, by the access router of the destination, the received data message to a communication entity of the destination. The DR may be a router of a domain network formed in the overlay form using the access router.

The identifier may include an EID for identifying the communication entity and a DID for identifying the domain network.

The receiving of the data message may include, receiving, by the communication entity of the source, an EID and a DID corresponding to a name of the destination from the GNS, and transmitting, by the communication entity of the source, the data message to the access router or the DR of the source based on the received EID and DID.

The transmitting of the data message to the access router of the destination may include, obtaining, by the access router or the DR of the source, a locator with respect to an EID of the destination included in the received data message, and transmitting by the access router or the DR of the source, the data message to the access router of the destination based on the obtained locator.

Still another exemplary embodiment of the present invention provides a communication method using a convergence network including an underlying network, at least one domain network configured in an overlay form using an access router of the underlying network and configured to have a different identifier based on a communication type or a service type, and a GNS, the method including: receiving, by a DDR of a source, a data message from a communication entity of the source; performing, by the DDR of the source, a hash operation using an identifier of a destination included in the received data message, and transmitting the data message to a DDR of the destination based on a result of performing; and transmitting, by the DDR of the destination, the data message to a communication entity of the destination based on a locator with respect to an identifier of the destination included in the data message. A DR may be a router of a domain network configured in the overlay form using the access router, and the DDR may be as DR selected from among a plurality of DRs to observe the domain network.

The identifier may include an EID for identifying the communication entity and a DID for identifying the domain network.

The receiving of the data message may include, receiving, by the communication entity of the source, an EID and a DID corresponding to a name of the destination from the GNS, transmitting, by the communication entity of the source, the data message to the access router or the DR of the source based on the received EID and DID, and forwarding, by the access router or the DR of the source, the transmitted data message to the DDR/

The transmitting of the data message to the communication entity of the destination may include, obtaining, by the DDR of the destination, a locator with respect to an EID of the destination included in the data message, transmitting by the DDR of the destination, the data message to the access router or the DR of the destination based on the obtained locator, and transmitting by the access router or the DR of the destination, the data message to the communication entity of the destination.

According to exemplary embodiments of the present invention, it is possible to effectively provide a content based service by configuring a dynamic domain network using a programmable overlay scheme on an underlying network based on a communication type or a service type, by defining a new identifier for the configured domain network, and by enabling communication between different domain networks based on the defined identifier.

According to exemplary embodiments of the present invention, it is possible to effectively provide a mobility service by configuring a dynamic domain network using a programmable overlay scheme on an underlying network based on a communication type or a service type, by defining a new identifier for the configured domain network, and by enabling communication between different domain networks based on the defined identifier.

According to exemplary embodiments of the present invention, it is possible to dynamically configure a network by configuring a dynamic domain network using programmable overlay scheme on an underlying network based on a communication type or a service type, by defining a new identifier for the configured domain network, and by enabling communication between different domain networks based on the defined identifier.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating architecture of a convergence network according to an exemplary embodiment of the present invention.

FIG. 2 is a diagram illustrating a protocol stack of convergence network architecture according to an exemplary embodiment of the present invention.

FIG. 3 is a diagram to describe a principle of configuring a domain network according to an exemplary embodiment of the present invention.

FIG. 4 is a flowchart illustrating a process of registering and obtaining an end ID (EID) and a domain ID (DID) according to an exemplary embodiment of the present invention.

FIG. 5 is a flowchart illustrating a communication process between terminals according to an exemplary embodiment of the present invention.

FIG. 6 is a flowchart illustrating a communication process between terminals according to another exemplary embodiment of the present invention.

FIG. 7 is a diagram illustrating convergence network architecture based on a mobility oriented future Internet (MOFI) enterprise domain according to an exemplary embodiment of the present invention.

FIG. 8 is a diagram illustrating convergence network architecture based on a content domain according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

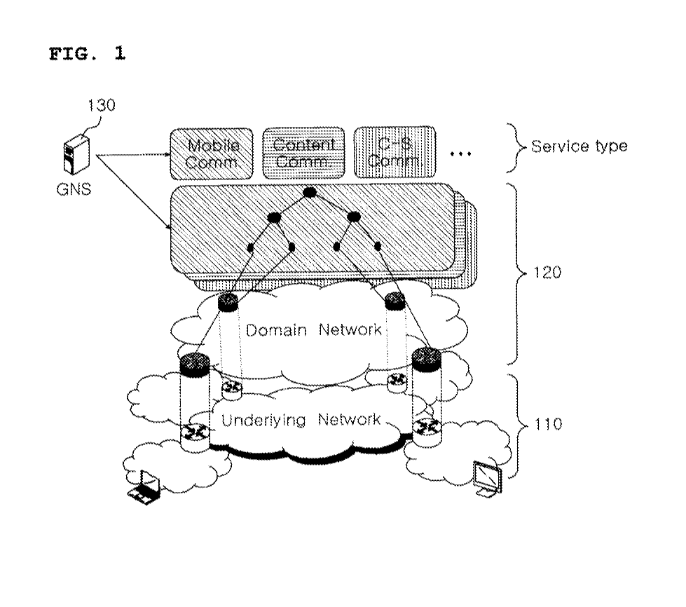

Hereinafter, a convergence network based on an identifier and a communication method using the same according to exemplary embodiments of the present invention will be described in detail with reference to the accompanying FIGS. 1 to 8. A description will be mace based on a portion required to understand an operation and effect according to the present invention.

In describing constituent elements of the present invention, different reference numerals may be assigned to constituent elements of the same name based on drawings, and like reference numerals may also be assigned thereto even though the constituent elements are illustrated in different drawings. However, even in this case, it does mean that a corresponding constituent element has a different function based on an exemplary embodiment or has an identical function in a different exemplary embodiment. A function of each constituent element needs to be determined based on a description related to each constituent element in a corresponding exemplary embodiment.

In particular, the present invention proposes new convergence network architecture that differently configures a domain network using a programmable overlay scheme on an underlying network based on a communication type or a service type, defines a new identifier for the configured domain network, and enables communication between different domain networks based on the defined identifier, and a communication method using the same.

FIG. 1 is a diagram illustrating architecture of a convergence network according to an exemplary embodiment of the present invention.

As illustrated in FIG. 1, the convergence network according to the present invention may include an underlying network 110, a domain network 120, and a general name server (GNS) 130. In the present invention, it is assumed that the underlying network 110 is provided in network based ID/locator separation architecture, such as a locator identifier separation protocol (LISP), mobility oriented future Internet (MOFI), and the like, for flexible and scalable domain networking.

The underlying network 110 basically includes a router to separate an ID and a locator of a host. An access network is formed on the underlying network 110 based on the router.

The domain network 120 is formed using such the ID/locator separation based router, and may be configured in a flexibly programmable overlay form based on a communication type or a service type. Here, a router used to configure a network is referred to as a domain router (DR), and a DR representing each domain network is referred to as a domain designate router (DDR).

Such a domain based network may look like an Internet protocol (IP) overlay network. However, the architecture thereof is used as one of programmability and a network virtualization scheme of a software defined network (SDN). As a matter of fact, the present architecture may be incrementally deployed, which may be an advantage obtained due to flexible architecture such as an overlay network.

Even though the existing Internet uses a protocol stack including five layers, the convergence network architecture according to the present invention uses a new layer.

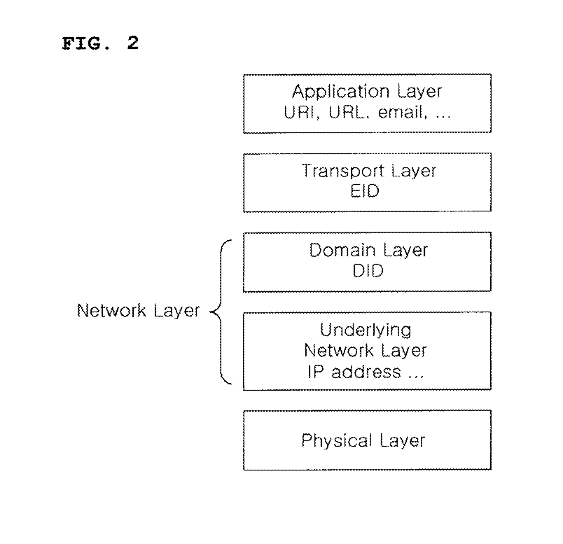

FIG. 2 is a diagram illustrating a protocol stack of convergence network architecture according to an exemplary embodiment of the present invention.

As illustrated in FIG. 2, the present invention defines a new ID system for communication. Basically, similar to being used in ID/locator separation architecture, an end point ID (EID) for identifying an actual communication entity and a domain ID (DID) for identifying a domain network configured based on a communication type or a communication service are newly defined.

Here, in addition to that the EID is used in a transport layer and an IP address is used in a network layer, the network layer uses the DID by adding a flexible domain layer.

The protocol stack used in the convergence network architecture according to the present invention may include a physical layer, an underlying network layer, the domain layer, the transport layer, and an application layer.

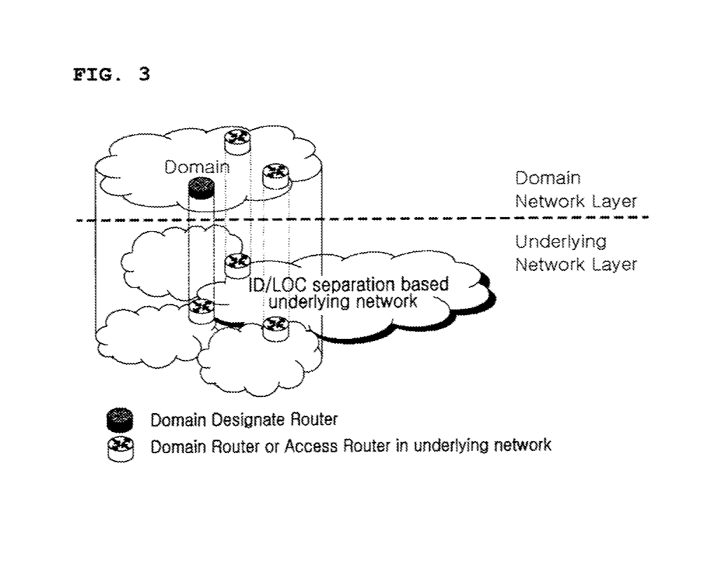

FIG. 3 is a diagram to describe a principle of configuring a domain network according to an exemplary embodiment of the present invention.

As illustrated in FIG. 3, the domain network 120 according to the present invention is configured on the underlying network 110 based on ID/locator separation. In a network of an edge area of the initially accessed underlying network, an access router that supports ID/locator separation is positioned. This access router becomes a DR in the domain network.

A single domain may include a plurality of underlying networks. Therefore, a router that representatively manages the domain is required, among domain routers present within the plurality of underlying networks, respectively. This router becomes a DDR.

The DDR may be selected using an algorithm of selecting a rendezvous point (RP) such as multicast, and is involved in an actual network configured for domain routing. Even though a single DDR is operated in the present invention, at least one DDR may be operated in order to distribute load and avoid sing-point-of-failure between distributed nodes.

The GNS 130 may serve to simultaneously return an EID and a DID based on a name, which is different from a basic DNS that returns an IP address. Here, for convenience, the GNS 130 may use current architecture, which is the same as the DNS. However, since binding information between the EID and the DID may vary, an additional function for supporting dynamic binding is required.

The GNS 130 may serve to obtain and register the EID and the DID that have a unique attribute in a “name” such as a universal resource locator (URL) for a communication entity. To this end, the GNS 130 may require “names” for all of the communication entities and registration of EIDs and DIDs that are new fields corresponding thereto.

Here, the GNS 130 defines a record type for a new DID as shown in the following Table 1.

TABLE 1

| Type | Value | Description |
|---|---|---|
| DID | IANA assign | Return domain identifier |

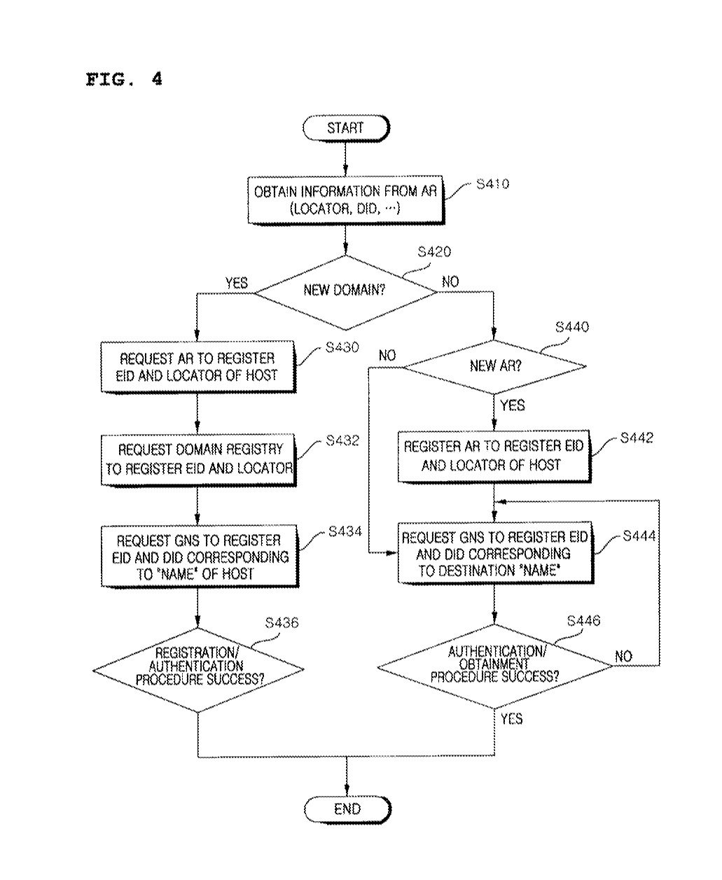

FIG. 4 is a flowchart illustrating a process of registering and obtaining an EID and a DID according to an exemplary embodiment of the present invention.

As illustrated in FIG. 4, initially, in the case of being connected to a new domain, a communication entity or a host may obtain information, such as a locator and a DID, from an access router (AR) of an underlying network of the communication entity or the host (S410), and may determine whether the communication entity or the host is connected to the new domain based on the obtained information such as the locator and the DID (S420).

Next, when it is determined that the host is connected to the new domain, the host may perform a registration procedure. That is, the host may request the AR to register EID and locator information of the host (S430). The AR may register the EID and locator information of the host to a domain registry (S432).

Next, the host may request a GNS to register an EID and a DID in order to inform that a new EID is present in a currently positioned domain (S434).

Next, the GNS may perform authentication between the GNS and the host using an attribute of a self-certifying ID, and may register the EID and the DID of the host as a result of performing (S436).

On the contrary, when it is determined that the host is connected to an existing domain, the host may verify whether the host has moved on the domain, that is, the AR is a new AR (S440), and may request the new AR to register the EID and the locator of the host when the AR is determined as the new AR as a result of verifying (S442).

Next, the host may perform a procedure of obtaining EID and DID information about a destination. That is, the host may request the GNS for EID and DID information corresponding to a “name” of the destination (S444).

Here, when the AR is not the new AR as a result of verifying, the host immediately requests the GNS for EID and DID information corresponding to the “name” of the destination.

Next, the GNS may perform authentication between the GNS and the host using an attribute of a self-certifying ID and may provide EID and DID information about the destination based on a result of performing.

Next, the host may obtain EID and DID information about the destination from the GNS (S446).

New two IDs are defined in the convergence network according to the present invention. The EID used to identify the communication entity is basically used for end-to-end communication. Even though the convergence network according to the present invention does not particularly define a new transport protocol that replaces an existing transmission control protocol (TCP) or a user datagram protocol (UDP) using the EID, the EID is designed to be used in this layer. Accordingly, a locator used in a network is required for communication between EIDs. However, even though the locator is obtained with respect to the EID, the locator may be used within a domain but the destination cannot be found in an inter-domain using the locator alone. This is because a routing locator is valid only in a routing protocol defined in a single domain.

Therefore, the convergence network according to the present invention is designed to use the DID for inter-domain routing and thus, the DID is used as an identifier of a domain and also used as a locator. Consequently, in the convergence network according to the present invention, a communication process initiates based on an EID, actual data is transferred using an underlying network locator on an intra-domain and using the DID on an inter-domain.

To design a network for the inter-domain, other requirements very different from requirements considered to design a single domain need to be considered, More than other things, a scalability issue needs to be solved in an interdomain network. Currently, the Internet also faces a scalability issue of a routing table in an inter-domain network area. This scalability issue should be solved in architecture that is newly designed.

The convergence network architecture according to the present invention is based on a flat DID in consideration of the aforementioned requirements and thus, is designed using an overlay network configuration algorithm that utilizes a distributed hash table (DHT) using the same. An actual DHT based overlay network configuring method may support all of the aforementioned scalability, survivability, and dynamicity.

However, even this case is inefficient for actual data transmission, which is the same as the aforementioned case. In particular, when the convergence network architecture is configured based on the flat DID in which topology information is not reflected at all, it may be further inefficient. Therefore, the convergence network architecture according to the present invention proposes generating a network by adding structural information to a DID. For a structural DHT, the convergence network architecture according to the present invention configures a DHT that may reflect regional architecture by adding regional information such as GPS to the DID.

Many researches on such a DHT algorithm have been conducted. Accordingly, it is possible to configure a domain network according to the present invention in a general ring form such as a chord, and to configure a ring by adding global positioning system (GPS) information to the DID. Accordingly, it is possible to configure the domain network based on an actual region.

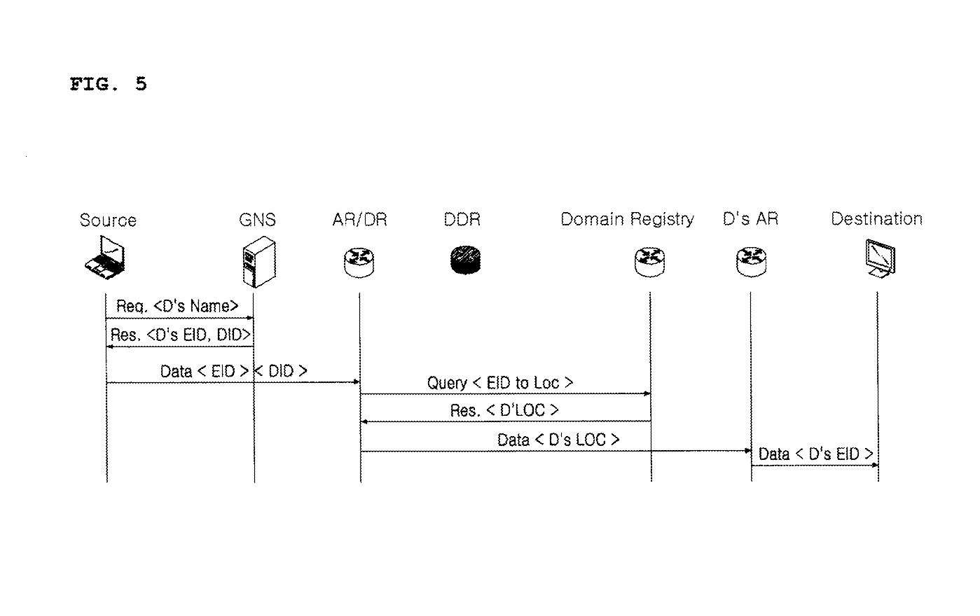

FIG. 5 is a flowchart illustrating a communication process between terminals according to an exemplary embodiment of the present invention.

As illustrated in FIG. 5, it is assumed that a destination is positioned on the same domain network as a source. Initially, a source terminal may transmits, to a GNS, a request message Req.<D's Name> for requesting EID and DID information corresponding to a “name” of a destination, and may receive, from the GNS, a response message Res.<D's EID, DID> for receiving EID and DID information corresponding to the “name” of the destination.

Next, the source terminal may obtain an EID and a DID from the received response message Res.<D's EID, DID>, and may determine whether the destination is positioned on a domain of the source terminal based on the obtained EID and DID.

Next, when the destination is positioned on the domain of the source terminal, the source terminal may transmit, to an AR or a DR, a data message Data<EID><DID> that includes the obtained EID and DID. Here, the data message Data<EID><DID> is a message that includes data to be transferred, and indicates a message configured so that the EID is inserted into a header and the DID is inserted into an option of the header.

Next, the AR or the DR may request a domain registry for a query message Query<EID to Loc> for requesting a locator with respect to the EID, and may receive, from the domain registry, a response message Res.<D'Loc> for providing the locator with respect to the EID.

Next, the AR or the DR may obtain the locator from the received response message Res.<D'Loc>, and may transmit the data message Data<D's Loc> to an AR of the destination (D's AR) based on the obtained locator.

Next, when the data message Data<D's Loc> is received, D's AR may transmit data to a target terminal by transmitting the data message Data<D's EID> to the target terminal.

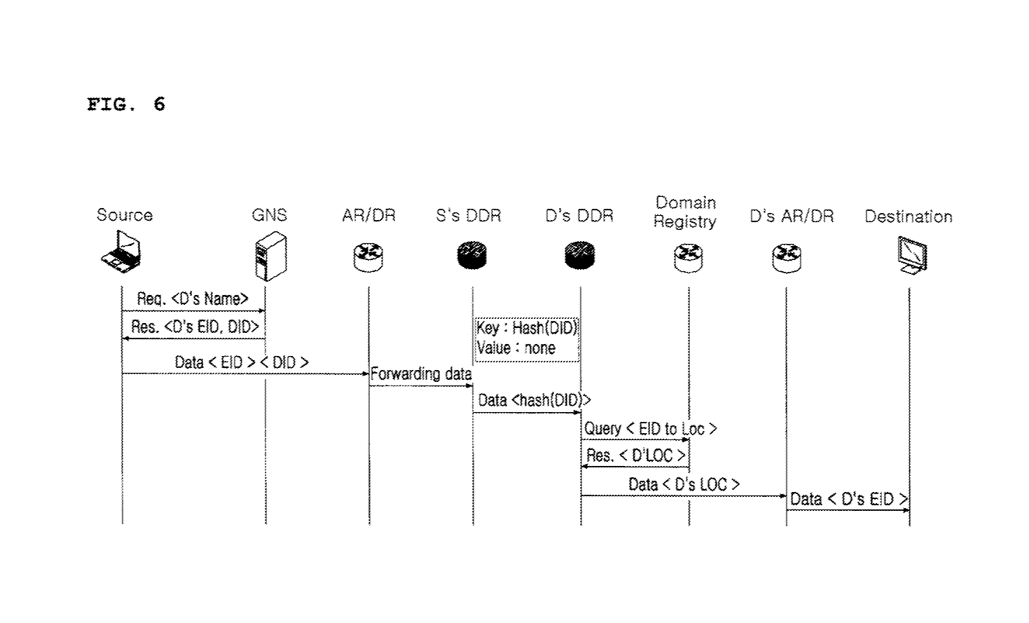

FIG. 6 is a flowchart illustrating a communication process between terminals according to another exemplary embodiment of the present invention.

As illustrated in FIG. 6, it is assumed that a destination is positioned on a domain network different from a source. Initially, a source terminal may transmit, to a GNS, a request message Req.<D's Name> for requesting EID and DID information corresponding to a “name” of the destination, and may receive, from the GNS, a response message Res.<D's EID, DID> for receiving EID and DID information corresponding to the “name” of the destination.

Next, the source terminal may obtain an EID and a DID from the received response message Res.<D's EID, DID>, and may determine whether the destination is positioned on a domain of the source terminal based on the obtained EID and DID.

Next, when the destination is positioned on the domain of the source terminal, the source terminal may transmit, to an AR or a DR, a data message Data<EID><DID> that includes the obtained EID and DID.

Next, the AR or the DR may forward the data message to a DDE of the source (S's DDR) on the domain of the AR or the DR.

Next, S's DDE may initiate inter-domain networking using the DID of the destination. For example, according to the present invention, in the case of configuring a DHT based domain network, S's DDE may perform a hash (DID) operation using the DID of the destination, and may transmit a data message Data<hash(DID)> to a DDE of the destination (D's DDE) based on a result of performing.

Next, D's DDR may request a domain registry for a query message Query<EID to Loc> for requesting a locator with respect to the EID, and may receive, from the domain registry, a response message Res.<D'Loc> for providing the locator with respect to the EID.

Next, D's DDR may obtain the locator from the received response message Res.<D'Loc>, and may transmit the data message Data<D's Loc> to an AR or a DR of the corresponding domain ('D's AR or DR) based on the obtained locator.

Next, when the data message Data<D's Loc> is received, D's AR or DR may transmit data to a target terminal by transmitting the data message Data<D's EID> to the target terminal.

According to the present invention, an AR or a DR of a source may obtain all of the information of a final destination using a control message and then directly transmit data using the obtained information. In particular, according to the present invention, when an inter-DDR network uses the same protocol, effective transfer may also be performed by simultaneously using a local locator, that is, a locator on a domain, and a global locator, that is, a locator of a DDR.

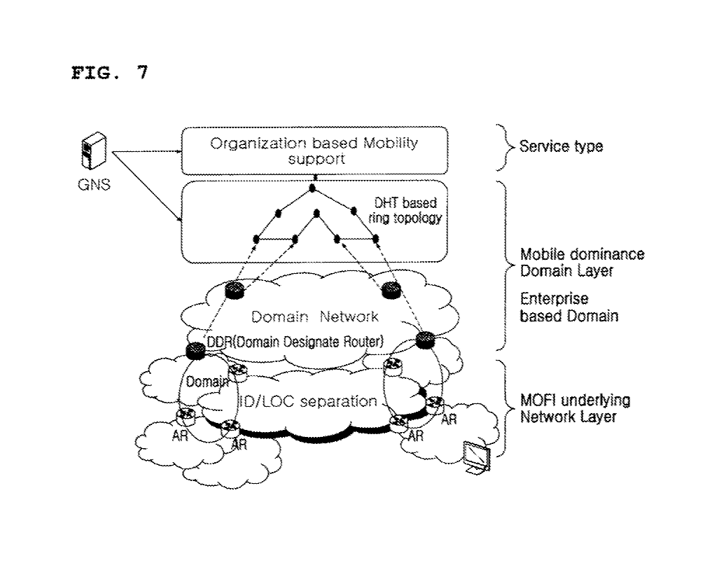

FIG. 7 is a diagram illustrating convergence network architecture based on a MOFI enterprise domain according to an exemplary embodiment of the present invention.

FIG. 7 illustrates convergence network architecture based on an enterprise domain configured on a MOFI underlying network.

Most enterprises manage lists of identifiers for an authentication procedure with respect to employees thereof, and communication may be easily performed within a reliable area. However, in the case of deviating from such a reliable domain, additional security functions such as firewalls and the like are configured. Most employees work while mutually migrating to branches distributed in a plurality of regions. Accordingly, in this architecture, it is possible to configure a domain using a softwarable (programmable) method by making a single enterprise as domains based on such a realistic environment.

Specifically, in the case of designing a domain based on architecture of an enterprise having the respective branches in big cities, ARs (domain routers) that provide connectivity for providing a network service to IDs of employees who work in all of the organizations and EIDs that indicate actual employees are distributed in the respective regions, and a registry that stores information between an EID and AR's locator is located in a single domain.

Each of the ARs is recognized as a domain router, and a DR that represents the domain is selected as a DDR. Generally, a DR in which a headquarter of the organization is present may be selected as the DDR, and an ID of the DDR is recognized as an ID of the corresponding domain. An algorithm for selecting a representative DR may use an idea such as an existing multicast protocol and the like.

To configure a domain as above and to perform inter-domain communication, it is possible to configure and connect a DHT ring using a DID that refers to each enterprise.

Consequently, most employees migrate within an enterprise thereof. Therefore, even in the case of migrating to a branch of the enterprise, no migration appears on a domain network and thus, communication may be easily performed without performing an unnecessary registration and authentication procedure.

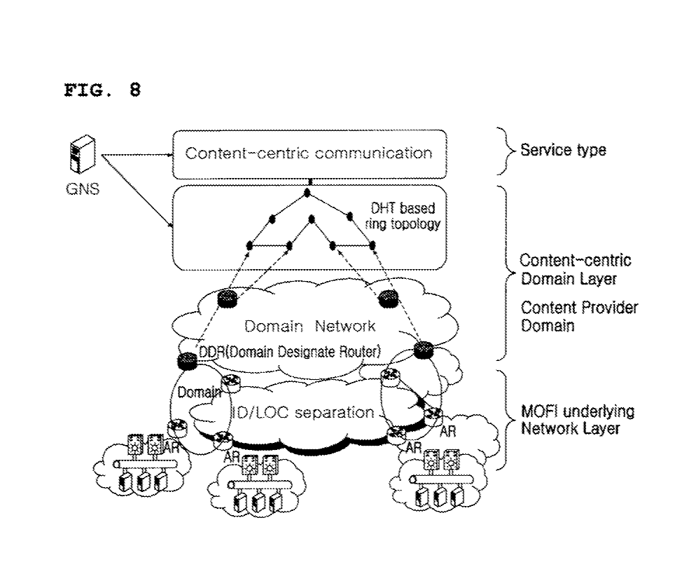

FIG. 8 is a diagram illustrating convergence network architecture based on a content domain according to an exemplary embodiment of the present invention.

FIG. 8 illustrates convergence network architecture based on a content domain configured on a MOFI underlying network.

Currently, a large capacity of multimedia service is being serviced by a content delivery network (CDN) provider such as Akami, and an Internet service provider (ISP) configures a CDN by configuring a data center thereof. That is, a content service and a network environment become more closely related.

To achieve network architecture for such a content service, a domain may be configured such as an area authorized by a content provider. This is because in the case of content or information, there is a need to know whether cloned content is actual data desired by a user, and for this, a security part such as inputting a signature of a content creator needs to be reinforced and thereby supported. Accordingly, in a domain such as a subscriber network generated by an actual content creator or provider, it is possible to use a service without worrying about security.

Accordingly, a provider such as KT needs to configure a domain for a single content service and to have, for each region, a registry for information of a subscriber EID and AR together with an AR for a subscriber network. Most content services are provided in a subscriber network and thus, most traffic occurs within a domain. Particularly, in the case of performing a global content business, a domain may be appropriately divided and thereby configured based on an underlying network circumstance.

Inter-domain communication may be configured using a DID that refers to a content provider, such as mobility support architecture. It may be important to configure a DHT ring based on an actual regional position using GPS information and the like. This is because large data may also be transferred toward an inter-domain network.

The present invention proposes a method that may dynamically configure a softwarable and programmable domain network to make it possible to support a communication type and service different from a current client-server type under ID/LOC separation architecture, which is a key point of the future Internet architecture.

By proposing architecture in which ID based communication may be performed by defining a new ID for the domain network, scalability capable of supporting any service or terminal, flexibility, and easy incremental deployment may be achieved.

For improving performance, it is possible to configure simple architecture by directly employing all of a domain locator and an inter-domain locator on a current IPv4 based network.

Consequently, the present architecture may quickly and flexibly a new service by configuring a programmable domain network such as an SDN on an existing infrastructure, and may also efficiently perform mobility support and content support that are currently biggest issues in the future Internet.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A convergence network based on an identifier, the convergence network comprising:
an underlying network including a plurality of communication entities and an access router configured to separate IDs and locators of the communication entities;
at least one domain network configured in an overlay form using the access router, and configured to have a different identifier based on a communication type or a service type; and
a global, name server (GNS) configured to register an identifier for identifying each of a communication entities and a domain network,
wherein the communication entities communicate over the at least one domain network using the identifier.

2. The convergence network of claim 1, wherein the identifier includes an end point ID (EID) for identifying the communication entity and a domain ID (DID) for identifying the domain network.

3. The convergence network of claim 2, wherein the communication entity obtains the locator and the DID from the access router of the underlying network of the communication entity in the case of being connected to any one domain network, and thereby determines whether the communication entity is connected to a new domain network using the obtained locator and DID, and requests the GNS to register the EID and the DID of the communication entity when the communication entity is connected to the new domain network as a result of determining.

4. The convergence network of claim 3, wherein the communication entity provides the EID and the locator of the communication entity to the access router and thereby requests the access router to register the provided EID and locator to a domain registry.

5. The convergence network of claim 2, wherein the communication entity provides a name of a destination to the GNS, and receives an EID and a DID corresponding to the name of the destination from the GNS.

6. The convergence network of claim 1, wherein the domain network includes:
a plurality of domain routers (DRs) configured in the overlay form using the access router; and
a domain designate router (DDR) selected from among the plurality of DRs as a DR to observe a corresponding domain network.

7. The convergence network of claim 6, wherein when receiving a data message from a communication entity of a source, the DR obtains a locator with respect to an EID a destination included in the received data message, and transmits the data message to a communication entity of the destination via an access router of the destination based on the obtained locator.

8. The convergence network of claim 6, wherein
when receiving a data message from a communication entity of a source, the DR forwards the received data message to a DDR of the source,
the DDR of the source performs a hash operation using a DID of a destination included in the forwarded data message, and transmits the data message to a DDR of the destination based on a result of performing, and
the DDR of the destination transmits the data message to a communication entity of the destination via an access router of the destination based on a locator with respect to an EID of the destination included in the transmitted data message.

9. The convergence network of claim 2, wherein the domain network is configured in a distributed hash table (DHT) based ring form to be capable of performing routing using the DID.

10. The convergence network of claim 1, wherein the convergence network uses a protocol stack including a physical layer, an underlying network layer based on an Internet protocol (IP) address, a domain layer based on a DID for identifying a domain network, a transport layer based on an EID, and an application layer.

11. A communication method using a convergence network comprising an underlying network, at least one domain network configured in an overlay form using an access router of the underlying network and configured to have a different identifier based on a communication type or a service type, and a GNS, the method comprising:
receiving, by an access router or a DR of a source, a data message of a communication entity of the source;
transmitting, by the access router or the DR of the source, the data message to an access router of a destination based on a locator with respect to an identifier of the destination included in the received data message; and
transmitting, by the access router of the destination, the received data message to a communication entity of the destination,
wherein the DR is a router of a domain network formed in the overlay form using the access router.

12. The method of claim 11, wherein the identifier includes an EID for identifying the communication entity and a DID for identifying the domain network.

13. The method of claim 12, wherein, the receiving of the data message includes,
receiving, by the communication entity of the source, an EID and a DID corresponding to a name of the destination from the GNS, and
transmitting, by the communication entity of the source, the data message to the access router or the DR of the source based on the received EID and DID.

14. The method of claim 12, wherein, the transmitting of the data message to the access router of the destination includes,
obtaining, by the access router or the DR of the source, a locator with respect to an EID of the destination included in the received data message, and
transmitting, by the access router or the DR of the source, the data message to the access router of the destination based on the obtained locator.

15. A communication method using a convergence network comprising an underlying network, at least one domain network configured in an overlay form using an access router of the underlying network and configured to have a different identifier based on a communication type or a service type, and a CNS, the method comprising:
receiving, by a DDR of a source, a data message from a communication entity of the source;
performing, by the DDR of the source, a hash operation using an identifier of a destination included in the received data message, and transmitting the data message to a DDR of the destination based on a result of performing; and
transmitting, by the DDR of the destination, the data message to a communication entity of the destination based on a locator with respect to an identifier of the destination included in the data message,
wherein a DR is a router of a domain network configured in the overlay form using the access router, and the DDR is a DR selected from among a plurality of DRs to observe the domain network.

16. The method of claim 15, wherein the identifier includes an EID for identifying the communication entity and a DID for identifying the domain network.

17. The method of claim 16, wherein
the receiving of the data message includes,
receiving, by the communication entity of the source, an EID and a DID corresponding to a name of the destination from the GNS,
transmitting, by the communication entity of the source, the data message to the access router or the DR of the source based on the received EID and DID, and
forwarding, by the access router or the DR of the source, the transmitted data message to the DDR.

18. The method of claim 16, wherein
the transmitting of the data message to the communication entity of the destination includes,
obtaining, by the DDR of the destination, a locator with respect to an EID of the destination included in the data message,
transmitting, by the DDR of the destination, the data message to the access router or the DR of the destination based on the obtained locator, and
transmitting, by the access router or the DR of the destination, the data message to the communication entity of the destination.
